(19) United States
(12) Patent Application Publication
(10) Pub. No.: US 2020/0151769 A1
(43) Pub. Date: May 14, 2020

(54) INFORMATION SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Tsugumi OTSUKA, Nagoya-shi (JP); Kazuya NISHIMURA, Okazaki-shi (JP); Yuki ITO, Iwakura-shi (JP); Akio UOTANI, Nagoya-shi (JP); Makoto AKAHANE, Nagoya-shi (JP); Wataru SHIINA, Nagoya-shi (JP)

(73) Assignee: TOYOTA JIDOSHA KABUSHIKI KAISHA, Toyota-shi (JP)

(21) Appl. No.: 16/670,471

(22) Filed: Oct. 31, 2019

(30) Foreign Application Priority Data
Nov. 12, 2018 (JP) 2018-212216

(51) Int. Cl. G06Q 30/02; G01C 21/36; G01C 21/34; G08G 1/00

(52) U.S. Cl. CPC G06Q 30/0266; G08G 1/205; G01C 21/3476; G01C 21/3605

(57) ABSTRACT

Advertisement information desired by a user is effectively provided when a trip or a travel is made by using a moving body such as a vehicle or the like. An information system comprises a controller comprising at least one processor configured to execute acquisition of destination information relevant to a destination and route information relevant to a route until arrival at the destination of a second vehicle which chases a first vehicle; and display of advertisement information relevant to the destination information and the route information in relation to the second vehicle, on a display unit which is provided on the first vehicle and which displays information with respect to those disposed at the back of the first vehicle.

### CROSS REFERENCE TO RELATED APPLICATION

This application claims the benefit of Japanese Patent Application No. 2018- 212216, filed on Nov. 12, 2018, which is hereby incorporated by reference herein in its entirety.

### BACKGROUND

### Technical Field

The present disclosure relates to an information system, an information processing method, and a non-transitory storage medium in which a vehicle is used as a display medium for an advertisement.

### Description of the Related Art

In recent years, the information communication technique, which is available for a moving body such as a vehicle or the like, is highly sophisticated. Further, it has been suggested that a moving body is utilized as a display medium for an advertisement or the like. For example, Patent Literature 1 discloses such a technique that a personal liking or taste is acquired from a following vehicle by the aid of the inter-vehicle communication, and an advertisement content, which is adapted to the liking or taste, is displayed on a back portion of a vehicle.

### PRIOR ART LITERATURE

### Patent Literature

Patent Literature 1: Japanese Patent Application Laid-Open No. 2016-66358

### SUMMARY

In the meantime, when a trip or a travel is made by using a moving body such as a vehicle or the like, the user of course expects the advertisement adapted to the hobby and/or the taste. However, the user also expects, in some cases, the advertisement of, for example, a store and/or a sightseeing area existing at a destination or on a route to arrive at the destination. In the case of the background art as described above, no consideration is made in relation to such expectation. Further, if the advertisement is always displayed on a back portion of a vehicle which precedes a subject vehicle, it is also feared that the guarantee of the safety may be damaged during the traveling. In view of the above, an object of the present disclosure is to effectively provide advertisement information desired by a user when a trip or a travel is made by using a moving body such as a vehicle or the like.

One aspect of the present disclosure may be exemplified as an information system. This information system may comprise a controller comprising at least one processor configured to execute acquisition of destination information relevant to a destination and route information relevant to a route until arrival at the destination of a second vehicle which chases a first vehicle; and display of advertisement information relevant to the destination information and the route information in relation to the second vehicle, on a display unit which is provided on the first vehicle and which displays information with respect to those disposed at the back of the first vehicle.

Another aspect of the present disclosure may be exemplified as an information processing method. The present disclosure may reside in an information processing method comprising acquiring destination information relevant to a destination and route information relevant to a route until arrival at the destination of a second vehicle which chases a first vehicle; and displaying advertisement information relevant to the destination information and the route information in relation to the second vehicle, on a display unit which is provided on the first vehicle and which displays information with respect to those disposed at the back of the first vehicle.

Still another aspect of the present disclosure may be exemplified as a program to be executed by a computer. The present disclosure may reside in program for allowing a computer to execute acquisition of destination information relevant to a destination and route information relevant to a route until arrival at the destination of a second vehicle which chases a first vehicle; and display of advertisement information relevant to the destination information and the route information in relation to the second vehicle, on a display unit which is provided on the first vehicle and which displays information with respect to those disposed at the back of the first vehicle, or a non-transitory storage medium on which the program is stored.

According to the present disclosure, it is possible to effectively provide the advertisement information desired by a user when a trip or a travel is made by using a moving body such as a vehicle or the like.

### BRIEF DESCRIPTION OF THE DRAWINGS

FIG. 1 illustrates exemplary system configuration of an advertisement system according to a first embodiment.

FIG. 2 illustrates respective exemplary hardware configuration of an advertisement delivery server and vehicle onboard apparatuses.

FIG. 3 illustrates exemplary functional configuration of the vehicle onboard apparatus.

FIG. 4 illustrates exemplary functional configuration of the advertisement delivery server.

FIG. 5 illustrates exemplary user information stored in user information DB.

FIG. 6 illustrates exemplary advertisement information stored in advertisement information DB.

FIG. 7 illustrates a sequence diagram illustrating an exemplary processing procedure executed by the advertisement delivery server and the vehicle onboard apparatuses.

FIG. 8 illustrates a flow chart illustrating a detailed exemplary process of S2.

FIG. 9 illustrates a flow chart illustrating a detailed exemplary process of S3.

FIG. 10 illustrates a flow chart illustrating a detailed exemplary process of S4.

FIG. 11 illustrates a flow chart illustrating a detailed exemplary process of S5.

### DESCRIPTION OF THE EMBODIMENTS

An advertisement system according to an embodiment of the present disclosure may be such a system that when a moving body such as a vehicle or the like, which follows a subject vehicle, travels or transfers for the purpose of a trip or the like, the advertisement information, which is desired by a user who gets on the following vehicle, is effectively provided. Those exemplified as the moving body such as the vehicle or the like include, for example, billboard trucks (advertising trucks) and public transport facilities including, for example buses and taxies each of which has a display apparatus for displaying advertisement information toward the back of the vehicle, as well as general vehicles including, for example, trucks, SUV's (Sport Utility Vehicles), and sedans. It is also possible to affirm that the user, who gets on the vehicle, is an end-user who utilizes the transfer or transport by using the vehicle, or a consumer who enjoys the service which is presented by the delivered advertisement information.

The advertisement system according to the embodiment of the present disclosure may be configured such that the whereabouts information (destination information, route information) relevant to the whereabouts or destination of the second vehicle which chases the first vehicle that precedes and travels is acquired. Then, the advertisement system may be configured such that the advertisement information relevant to the whereabouts information of the second vehicle is displayed with respect to those disposed at the back in which the second vehicle chases, by the aid of a display unit provided on the first vehicle. According to the configuration as described above, when the trip or the travel is made by means of the second vehicle, the advertisement information relevant to the whereabouts information of the second vehicle can be displayed with respect to those disposed at the back of the vehicle by the aid of the display unit of the first vehicle. Therefore, it is possible to effectively provide the advertisement information desired by the user.

The advertisement system may display the advertisement information if the second vehicle is in a driving assistance state in which the second vehicle travels in accordance with a set speed value, or if the second vehicle is in a driving assistance state in which the second vehicle travels while maintaining a constant following distance with respect to the first vehicle. The driving operation of the driver is assisted in the driving state in which the driving assistance function is used. Therefore, the advertisement information can be provided while considering the traveling safety. Further, the second vehicle may be constructed to refuse provision of any data relevant to the whereabouts information. It is possible to suppress any unnecessary outflow of the personal information of the user while considering the intention of the user who does not desire the provision of the whereabouts information.

An embodiment will be explained below with reference to the drawings. The configuration of the following embodiment is shown by way of example. The mode for carrying out the disclosure is not limited to the configuration of the embodiment explained below.

### First Embodiment

(System Outline)

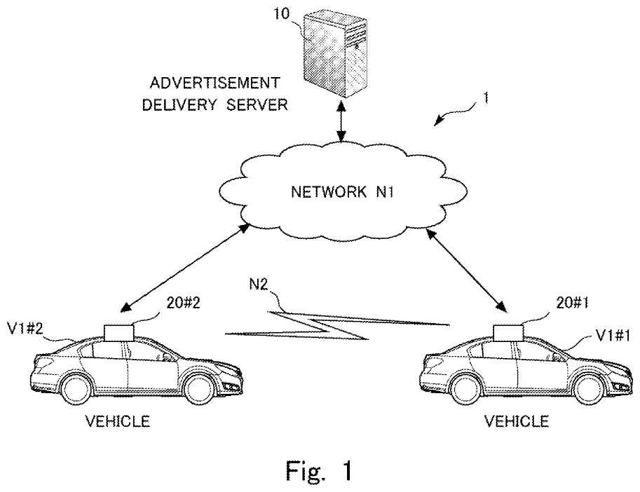

FIG. 1 illustrates exemplary system configuration of an advertisement system 1 according to a first embodiment. The advertisement system 1 illustrated in FIG. 1 is such a system that when a moving body such as a vehicle or the like, which follows a subject vehicle, travels or transfers for the purpose of a trip or the like, the advertisement information, which is desired by a user who gets on the following vehicle, is effectively provided. In this embodiment, the vehicle has at least a display apparatus for displaying the advertisement information with respect to the following vehicle, at a back portion of the vehicle. The advertisement information includes the advertisement content including, for example, the still image, the moving image (screen image), and the message information provided by the advertiser (for example, an enterprise or an agency that provides the merchandise and/or the service), and the privilege information (for example, coupon, point, and discount). The advertisement system 1 is an example of the “information system”.

The advertisement system 1 according to this embodiment is constructed to include an advertisement delivery server 10, a vehicle onboard apparatus 20#1, and a vehicle onboard apparatus 20#2 which are connected to one another by means of a network N1. The vehicle onboard apparatus 20#1 is an apparatus which is carried on a vehicle V1#1 that travels while preceding, and the vehicle onboard apparatus 20#2 is an apparatus which is carried on a vehicle V1#2 that travels while following the vehicle V1#1. The network N1 is, for example, a public network including, for example, the internet. However, the network N1 may include the wireless communication such as WiFi (registered trademark) or the like, the wireless network of the mobile phone network such as LTE, LTE-Advanced, 3G or the like, the exclusive network such as VPN (Virtual Private Network) or the like, and the network such as LAN (Local Area Network) or the like.

Further, the vehicle onboard apparatus 20#1 and the vehicle onboard apparatus 20#2 can be directly communicated with each other via a network N2. The network N2 is, for example, a wireless communication network of the 5th generation mobile communication system (5G) which makes it possible to perform the inter-vehicle communication and the road-vehicle communication. However, the network N2 may include, for example, UWB (Ultra-Wideband), WiFi, and BLE (Bluetooth (registered trademark) Low Energy). The network N2 may be included in the network N1. In the following description, an explanation will be made assuming that the vehicle onboard apparatus 20#1, which is carried on the vehicle V1#1, performs the inter-vehicle communication via the network N2 with respect to the vehicle onboard apparatus 20#2 which is carried on the vehicle V1#2.

Note that in FIG. 1, one advertisement delivery server 10, the vehicle onboard apparatus 20#1 carried on the vehicle V1#1, and the vehicle onboard apparatus 20#2 carried on the vehicle V1#2 are representatively exemplified. A plurality of advertisement delivery servers 10 may be connected to the network N1. Further, any number of vehicle onboard apparatuses may be connected to the network N1. In the following description, the vehicle V1#1, which travels while preceding, is also referred to as “preceding vehicle V1”, and the vehicle V1#2, which travels while following the vehicle V1#1, is also referred to as “chasing vehicle V1”. The plurality of vehicles are collectively and simply referred to as “vehicle V1” as well. Similarly, the vehicle onboard apparatus 20#1, which is carried on the preceding vehicle V1, is also referred to as “apparatus 20#1”, and the vehicle onboard apparatus 20#2, which is carried on the chasing vehicle V1, is also referred to as “apparatus 20#2”. The plurality of vehicle onboard apparatuses are collectively referred to as “apparatus 20” as well. Further, the advertisement delivery server 10 is simply referred to as “server 10” as well.

The vehicle V1 has a display apparatus which is disposed at a back portion of the vehicle and which is provided to display the advertisement information with respect to the vehicle that follows the subject vehicle. The display apparatus is provided, for example, on the outer wall disposed at the back portion of the body so that viewers, who exist around the vehicle V1, can visually recognize the displayed advertisement information from the outer side of the vehicle. That is, at least, the advertisement information is displayed toward the back of the vehicle V1. The display apparatus is constructed by using, for example, a liquid crystal display such as LCD (Liquid Crystal Display) or the like, an organic EL (Electro-Luminescence) display, an LED (Light Emitting Diode) matrix, or a projector.

Note that in this embodiment, the vehicle V1 will be explained as the vehicle which has the display apparatus at the back portion of the vehicle. However, as for the arrangement position of the display apparatus, for example, the display apparatuses may be arranged at a plurality of positions including, for example, the left side surface, the right side surface, and the upper portion of the vehicle, other than the back portion of the vehicle. Further, any arrangement position of the display apparatus other than the above may be adopted. For example, if a projector or the like is provided, the window glass of the vehicle (for example, rear window, side window), on which the screen image can be projected, can be exemplified as the arrangement position.

The vehicle V1 receives, for example, the advertisement information including the data (advertisement data) of the advertisement content delivered from the server 10 by the aid of the apparatus 20. Then, the vehicle V1 displays the delivered advertisement information on at least the display apparatus provided at the vehicle back portion of the subject vehicle. The advertisement content, which includes, for example, the still image, the slide show, the moving image (screen image), and the message information based on the advertisement data, is provided to the user of the chasing vehicle V1 which travels while following the subject vehicle.

The apparatus 20 is a vehicle onboard apparatus carried on the vehicle V1. Identification information (apparatus ID), which is usable to unambiguously identify the apparatus, is previously given to the apparatus 20. The apparatus ID is managed while being correlated, for example, with identification information (for example, automobile registration number (number marked on number plate or license plate)) for unambiguously identify the vehicle V1 which carries the apparatus 20. The apparatus 20 transmits the state information for indicating the state relevant to the traveling of the subject vehicle, to the server 10 periodically or in response to the request from the server 10. For example, the position information (latitude, longitude) of the vehicle V1, the speed information, and the information to indicate the traveling direction are exemplified as the state information. The apparatus 20 transmits the state information of the subject vehicle to the server 10 together with the apparatus ID.

The apparatus 20 according to this embodiment (apparatus 20#1 carried on the preceding vehicle V1) directly performs the inter-vehicle communication via the network N2 with respect to the chasing vehicle V1 which travels while following the subject vehicle. The apparatus 20#1 acquires, for example, the apparatus ID of the apparatus 20#2 carried on the chasing vehicle V1, by the aid of the inter-vehicle communication. Then, the apparatus 20#1 transmits a request for permission to acquire the whereabouts information relevant to the whereabouts or destination, with respect to the chasing vehicle V1. For example, the destination information (for example, latitude, longitude) of the chasing vehicle V1 and the route information to arrive at the destination are exemplified as the whereabouts information. Note that the destination information and the route information may include the identification information (for example, link number) of the road on which the vehicle is scheduled to travel and the identification information (for example, node number) of the intersection or the like. The whereabouts information is set, for example, by means of the input operation performed by the passenger who gets on the chasing vehicle V1.

For example, if the permission to acquire the whereabouts information is obtained from the apparatus 20#2 carried on the chasing vehicle V1, the apparatus 20#1 acquires the whereabouts information (for example, destination information, route information) in relation to the whereabouts or destination of the chasing vehicle V1. The whereabouts information, which relates to the whereabouts or destination of the chasing vehicle V1, is acquired by means of the inter-vehicle communication. For example, the acquired whereabouts information, the apparatus ID of the apparatus 20#2 carried on the chasing vehicle V1, and the time information are transmitted by the apparatus 20#1 to the server 10 while being correlated with each other.

Further, for example, if the permission to acquire the whereabouts information is not obtained from the apparatus 20#2 of the chasing vehicle V1, the apparatus 20#1 transmits the apparatus ID of the apparatus 20#2 to the server 10. The server 10 can select the advertisement information adapted, for example, to the hobby and the taste relevant to the user of the chasing vehicle V1, for example, on the basis of the apparatus ID of the apparatus 20#2, and the advertisement information can be displayed on the preceding vehicle V1. Note that the server 10 may take account of the position information of the preceding vehicle V1 which carries the apparatus 20#1, when the advertisement information, which is adapted, for example, to the hobby and the taste relevant to the user of the chasing vehicle V1, is selected. It is also possible to select and display the advertisement information of the store, the facility or the like adapted, for example, to the hobby and the taste of the user of the chasing vehicle V1 in the area in which the preceding vehicle V1 and the chasing vehicle V1 travel.

The server 10 according to this embodiment is the computer which manages the advertisement information delivered to the vehicle V1. The advertisement information is managed while the identification information (advertisement ID) for unambiguously identifying or distinguishing the information is given thereto. The server 10 retains, in the database, the advertisement information and the information relevant to the user of the vehicle V1 which carries the apparatus 20. The information (attribute information), which indicates the attribute of the user including, for example, the age, the distinction of sex, the occupation, the taste, and the hobby, is retained as the information relevant to the user.

The server 10 according to this embodiment selects the advertisement information to be displayed on the back portion of the vehicle of the preceding vehicle V1 on the basis of the whereabouts information relevant to the whereabouts or destination as acquired from the chasing vehicle V1. For example, the server 10 specifies the advertisement information of, for example, the store and/or the sightseeing area positioned at the destination of the chasing vehicle V1 or on the route to arrive at the destination, from the advertisement information managed by the server 10. Then, the server 10 delivers the selected advertisement information to the preceding vehicle V1. The apparatus 20 of the preceding vehicle V1 acquires the delivered advertisement information, and the advertisement information is displayed on the display apparatus provided at the back portion of the vehicle. The advertisement information of, for example, the store and/or the sightseeing area disposed at the destination or on the route to arrive at the destination is presented to the passenger of the chasing vehicle V1 which travels while following the preceding vehicle V1. According to this embodiment, it is possible to present the advertisement information in relation to the destination or the whereabouts desired by the passenger, with respect to the passenger who performs the driving operation for the chasing vehicle V1 to make the trip or the transfer or travel.

Note that the apparatus 20, which is carried on the preceding vehicle V1 of this embodiment, may allow the display apparatus provided at the back portion of the vehicle to display the advertisement information delivered from the server 10, if the driving state of the chasing vehicle V1 fulfills a predetermined condition. The driving state as described above is exemplified, for example, by a driving state in which the driver of the chasing vehicle V1 allows the cruise control to function so that the vehicle travels at a preset speed without continuously pedaling an accelerator pedal. Further, the driving state of the chasing vehicle V1 may be a driving state in which the following drive assistance function (radar cruise control) referred to as ACC (Adaptive Cruise Control) is allowed to function. The chasing vehicle V1, in which the following drive assistance function is allowed to function, can adjust the speed of the subject vehicle, for example, while maintaining a constant following distance with respect to the preceding vehicle V1 as detected by a radar, a camera or the like, and the chasing vehicle V1 can travel while following the preceding vehicle V1.

The apparatus 20, which is carried on the preceding vehicle V1, acquires, from the chasing vehicle V1, the information for indicating whether or not the chasing vehicle V1 is in the driving state in which the driving assistance function as described above is allowed to function, for example, by the aid of the inter-vehicle communication. Then, the apparatus 20 of the preceding vehicle V1 may display the advertisement information delivered from the server 10 on the display apparatus provided at the back portion of the vehicle, on condition that the driving state of the chasing vehicle V1 is the driving state in which the driving assistance function is allowed to function. The driving operation of the driver is assisted in the driving state in which the driving assistance function is used, and hence the load of the driving operation, which is exerted on the driver, is mitigated. Therefore, it is possible to secure the safety in the traveling environment. According to this embodiment, it is possible to safely present the advertisement information about the whereabouts or destination desired by the passenger, with respect to the passenger who performs the trip or the transfer by performing the driving operation for the chasing vehicle V1.

Further, in this embodiment, the whereabouts information relevant to the whereabouts or destination is acquired while placing the restriction on a case in which the permission of the chasing vehicle V1 is obtained. Therefore, it is possible to consider the intention of the driver who does not desire the provision of the whereabouts information. According to this embodiment, it is possible to realize the advertisement system in which any unnecessary outflow of the personal information is suppressed for the user who gets on the chasing vehicle V1.

(Hardware Configuration)

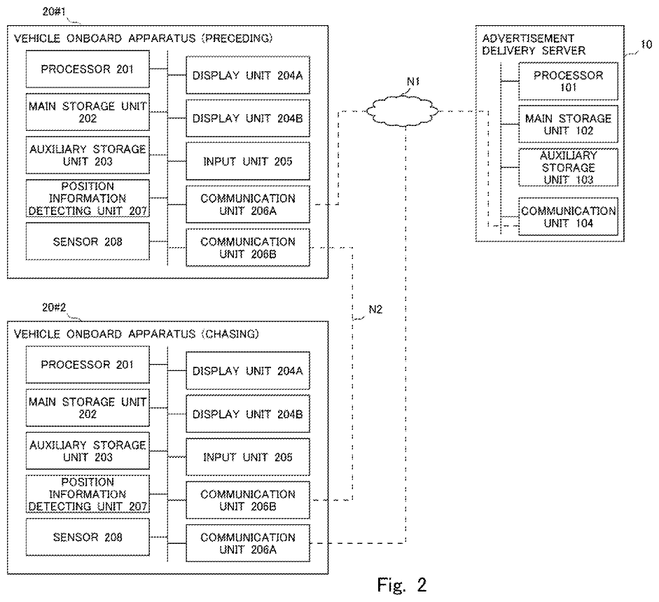

FIG. 2 illustrates an example of respective hardware configuration of the server 10, the apparatus 20#1 carried on the preceding vehicle V1, and the apparatus 20#2 carried on the chasing vehicle V1. Note that the apparatus 20#1 and the apparatus 20#2 are configured similarly or equivalently. In the following description, the apparatus 20#1 and the apparatus 20#2 will be explained as “apparatus 20”.

With reference to FIG. 2, the server 10 is, for example, a general purpose or exclusive computer. The server 10 includes constitutive components of a processor 101, a main storage unit 102, an auxiliary storage unit 103, and a communication unit 104 which are connected to one another by means of a bus. The main storage unit 102 and the auxiliary storage unit 103 are recording media capable of being read by the server 10. A plurality of constitutive components may be provided for each of the constitutive components as described above. Alternatively, it is also allowable that a part or parts of the constitutive component or components is/are not provided. The processor 101 of the server 10 is an example of the “controller”.

The processor 101 is, for example, CPU (Central Processing Unit). The processor 101 executes the computer program executably developed in the working area of the main storage unit 102, and the processor 101 controls the entire server 10. The processor 101 provides the function which conforms to a predetermined purpose by controlling the peripheral devices in accordance with the execution of the computer program. The processor 101 is not limited to a single processor. The processor 101 may be configured as a multiprocessor. Alternatively, single CPU, which is connected by a single socket, may be configured as a multicore. Note that a part or parts of the processing function provided by the server 10 may be provided, for example, by DSP (Digital Signal Processor), ASIC (Application Specific Integrated Circuit), or GPU (Graphics Processing Unit). Further, at least a part or parts of the processing function may be exclusive LSI (large scale integration) including, for example, FPGA (Field-Programmable Gate Array), numerical data processor, and image processing processor, or any other digital circuit or analog circuit.

The main storage unit 102 stores, for example, the computer program executed by the processor 101 and the data processed by the processor 101. The main storage unit 102 is, for example, a flash memory, RAM (Random Access Memory), or ROM (Read Only Memory). The auxiliary storage unit 103 is a nonvolatile storage device which readably/writably stores, on the recording medium, various programs including OS (Operating System) and various data. The auxiliary storage unit 103 is, for example, a flash memory, a hard disk drive (HDD, Hard Disk Drive), or SSD (Solid State Drive). Note that OS includes a communication interface program for accepting/delivering the data with respect to an external device or the like connected via the communication unit 104. The communication unit 104 is an interface with respect to the network N1. The communication unit 104 includes, for example, a LAN interface board and a wireless communication circuit for the wireless communication. The server 10 is connected to the network N1 via the communication unit 104 for making communication, for example, with the apparatuses 20#1, 20#2 via the network N1.

Note that the hardware configuration of the server 10 is not limited to the configuration illustrated in FIG. 2. The server 10 can read, for example, the program recorded on the transportable recording medium, the server 10 can develop the program in the main storage unit 102, and the server 10 can execute the program. The transportable recording medium is, for example, a disk recording medium such as USB (Universal Serial Bus) memory, CD (Compact Disc), DVD (Digital Versatile Disc), or Blu-ray (registered trademark) disk.

The apparatus 20 has a processor 201, a main storage unit 202, an auxiliary storage unit 203, a display unit 204A, a display unit 204B, an input unit 205, a communication unit 206A, a communication unit 206B, a position information detecting unit 207, and a sensor 208. The processor 201, the main storage unit 202, the auxiliary storage unit 203, and the communication unit 206A are the same as or equivalent to the processor 101, the main storage unit 102, the auxiliary storage unit 103, and the communication unit 104 of the server 10, and hence any explanation thereof will be omitted. A plurality of constitutive components may be provided for each of the constitutive components described above. Alternatively, it is also allowable that a part or parts of the constitutive components is/are not provided.

The display unit 204A is, for example, a display device such as LCD or EL (Electroluminescence) panel. The display unit 204A may be provided with a speaker or the like for announcing the voice guidance, the message and the like in the vehicle. The display unit 204B is the display apparatus provided at the back portion of the vehicle. The display unit 204B is constructed, for example, by a liquid crystal display such as LCD or the like, an organic EL display, an LED matrix, and/or a projector. The advertisement information delivered from the server 10 is presented to the chasing vehicle V1 by the aid of the display unit 204B.

The input unit 205 includes, for example, a touch panel or a push-button which is capable of inputting symbols such as letters or characters or the like, a microphone which is capable of inputting the voice, and a camera which is capable of photographing a moving image or a still image. The communication unit 206B is, for example, a communication circuit which is adapted to the wireless communication such as the 5th generation mobile communication system (5G), UWB, WiFi, BLE or the like. The apparatus 20#1 carried on the preceding vehicle V1 and the apparatus 20#2 carried on the chasing vehicle V1 perform the inter-vehicle communication by the aid of the respective communication units 206B.

The position information detecting unit 207 is the means for detecting the position information of the vehicle V1 on which the apparatus 20 is carried. The position information detecting unit 207 detects the position information of the subject vehicle (latitude, longitude), for example, on the basis of the GPS signals from a plurality of GPS (Global Positioning Satellite) satellites which orbit around the earth. The apparatus 20 performs the route guidance until arrival at the destination inputted by the operation by the aid of the input unit 205 on the basis of the position information detected by the aid of the position information detecting unit 207. The route until arrival at the destination is set by making reference to the map data stored in the auxiliary storage unit 203. The destination information relevant to the destination inputted by the operation and the route information relevant to the route until arrival at the destination set by making reference to the map data are retained in a predetermined area of the auxiliary storage unit 203. Note that the information to be retained may include the information of, for example, the transit point until arrival at the destination. The apparatus 20 provides the route guidance until arrival at the destination, for example, such that the detected position of the subject vehicle and the route until arrival at the destination are displayed in a superimposed manner on the map displayed by the aid of the display unit 204A, and/or the traveling direction including, for example, the turning to the right or left is guided by the aid of the voice or the like, for example, at the intersection.

The sensor 208 is an assembly of sensors carried on the vehicle V1. The sensor 208 includes one or more sensors for detecting the information relevant to the traveling state and the situation around the vehicle, including, for example, a vehicle speed sensor, an acceleration sensor, a radar, a camera, and an azimuth angle sensor. Further, the information detected by the sensor 208 includes the information which indicates that the driving assistance function such as the cruise control, the radar cruise control or the like of the vehicle V1 is effective. The information as described above is exemplified, for example, by the ON/OFF status or the like of the switch, the button or the like for allowing the driving assistance function to operate, as provided on the steering wheel and/or the instrument panel. Further, the information, which is detected by the sensor 208, may include, for example, the data relevant to, for example, the degree of congestion in the vicinity of the vehicle, the speeds of surrounding vehicles, and the control of traffic signals, as acquired by the aid of the road-vehicle communication and/or the inter-vehicle communication.

(Functional Configuration)

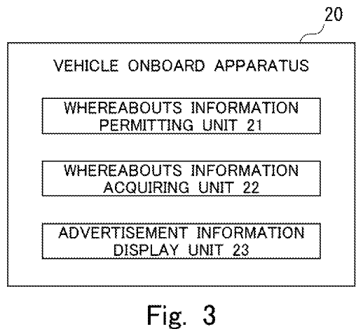

FIG. 3 illustrates exemplary functional configuration of the apparatus 20. The apparatus 20 includes a whereabouts information permitting unit 21, a whereabouts information acquiring unit 22, and an advertisement information display unit 23 as functional constitutive components. As for the functional constitutive components as described above, the functional constitutive components are provided, for example, such that the various programs, which are stored in the auxiliary storage unit 203, are developed and executed in the main storage unit 202 by means of the processor 201 of the apparatus 20. However, any one of the respective functional constitutive components or any part of the processing thereof may be executed by any hardware circuit.

The whereabouts information permitting unit 21 makes response about whether or not the whereabouts information (destination information, route information) relevant to the whereabouts or destination of the subject vehicle can be provided. The information relevant to whether or not the whereabouts information can be provided is previously set, for example, by the user of the vehicle V1. The apparatus 20 accepts the setting information to indicate whether or not the whereabouts information of the subject vehicle can be provided, for example, as inputted by the operation by the aid of the input unit 205, and the information is stored in a predetermined area of the auxiliary storage unit 203 or the like. The setting information is, for example, the information which is represented by the binary status value of the active for permitting the provision and the non-active for refusing the provision. For example, if a request to acquire the whereabouts information is made by the preceding vehicle V1 by the aid of the communication unit 206B, the whereabouts information permitting unit 21 makes response with respect to the request to acquire the whereabouts information in accordance with the setting information which indicates whether or not the whereabouts information can be provided and which is stored, for example, in the auxiliary storage unit 203.

If the apparatus 20#2 of the chasing vehicle V1 permits the acquisition, the whereabouts information acquiring unit 22 acquires the whereabouts information relevant to the whereabouts or destination of the chasing vehicle. For example, the whereabouts information of the chasing vehicle V1, which is acquired by the aid of the communication unit 206B, is transmitted by the whereabouts information acquiring unit 22 to the server 10 while allowing the whereabouts information to correspond to the apparatus ID of the apparatus 20#2. Note that if the apparatus 20#2 of the chasing vehicle V1 does not permit the acquisition of the whereabouts information, the apparatus ID of the apparatus 20#2 is transmitted to the server 10.

The advertisement information display unit 23 acquires the advertisement information delivered from the server 10, and the advertisement information is stored in a predetermined area of the auxiliary storage unit 203. Then, if the driving state of the chasing vehicle V1 is the driving state in which the cruise control or the radar cruise control is allowed to function, the advertisement information display unit 23 displays the advertisement information on the display apparatus (display unit 204B) arranged at the back portion of the vehicle. Note that if the driving state of the chasing vehicle V1 is the driving state in which the driving assistance function is not operated, the advertisement information display unit 23 displays the advertisement information, for example, on condition that the speed of the subject vehicle is lower than a previously set threshold value (for example, 20 km/h). The advertisement information display unit 23 displays the advertisement information in accordance with the information (for example, identifier) for designating the preferential display given to the advertisement information.

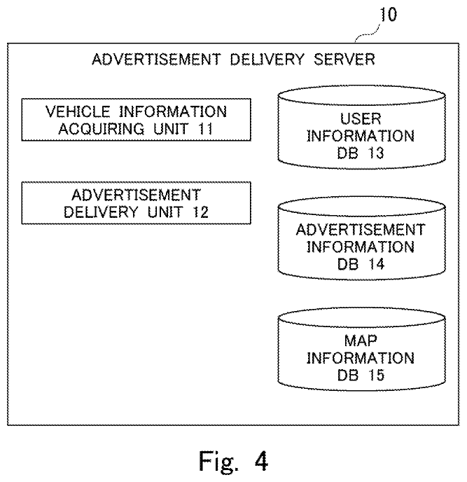

FIG. 4 illustrates exemplary functional configuration of the server 10. The server 10 includes a vehicle information acquiring unit 11, an advertisement delivery unit 12, a user information database (DB) 13, an advertisement information DB 14, and a map information DB 15 as functional constitutive components. As for the functional constitutive components as described above, the functional constitutive components are provided, for example, such that the various programs, which are stored in the auxiliary storage unit 103, are developed and executed in the main storage unit 102 by means of the processor 101 of the server 10. However, any one of the respective functional constitutive components or any part of the processing thereof may be executed by any hardware circuit. Further, any one of the respective functional constitutive components or any part of the processing thereof may be executed by any other computer connected to the network N1.

The vehicle information acquiring unit 11 acquires the information relevant to the chasing vehicle V1 transmitted from the preceding vehicle V1. The information relevant to the chasing vehicle V1 includes the apparatus ID of the apparatus 20#2 carried on the chasing vehicle V1 and the permitted whereabouts information (for example, destination information, route information) relevant to the whereabouts or destination of the chasing vehicle. The vehicle information acquiring unit 11 temporarily stores the information relevant to the chasing vehicle V1 in a predetermined area of the main storage unit 102. The vehicle information acquiring unit 11 delivers the information to the advertisement delivery unit 12. Note that the vehicle information acquiring unit 11 acquires, for example, the position information transmitted from the preceding vehicle V1 together with the apparatus ID of the apparatus 20#1 carried on the preceding vehicle. The position information and the apparatus ID of the preceding vehicle V1, which have been acquired, are stored in the main storage unit 102 together with the time information.

The advertisement delivery unit 12 selects the advertisement information to be displayed on the back portion of the vehicle of the preceding vehicle V1, on the basis of the information relevant to the chasing vehicle V1 as delivered from the vehicle information acquiring unit 11. The advertisement delivery unit 12 selects the advertisement information adapted, for example, to the hobby and the taste of the user of the chasing vehicle V1, for example, on the basis of the apparatus ID of the apparatus 20#2. Further, the advertisement delivery unit 12 selects the advertisement information of, for example, the store and/or the sightseeing area positioned at the destination or on the route to arrive at the destination of the chasing vehicle V1 on the basis of the whereabouts information. The advertisement information is selected by making reference to the user information DB 13 and the advertisement information DB 14.

Then, the advertisement delivery unit 12 delivers the selected advertisement information to the preceding vehicle V1. The advertisement delivery unit 12 gives the preference information (for example, an identifier for indicating the preference designation) which is available to preferentially display the advertisement information selected on the basis of the whereabouts information as compared with the advertisement information adapted, for example, to the hobby and/or the taste of the user of the chasing vehicle V1, and the information is delivered to the preceding vehicle V1. The preceding vehicle stores the advertisement information to which the preference information is given, in a predetermined area of the auxiliary storage unit 203.

The user information DB 13 manages the information relevant to the user of the vehicle V1 which carries the apparatus 20. The information relevant to the user is registered, for example, by the aid of an information processing terminal possessed by the user, including, for example, a smartphone, a tablet terminal, a personal information terminal, and PC (Personal Computer).

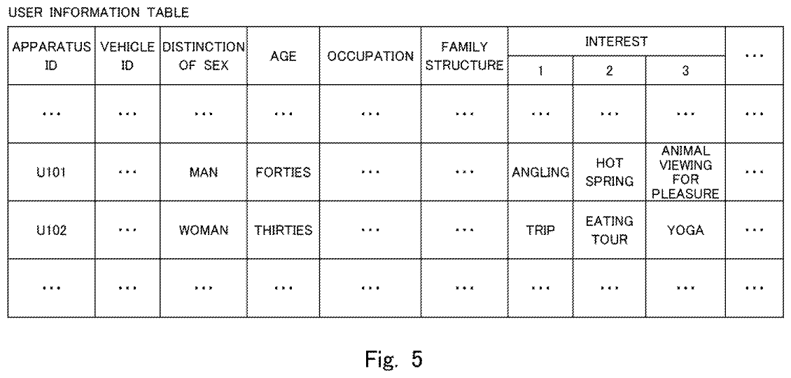

FIG. 5 illustrates exemplary user information stored in the user information DB 13. As exemplified in FIG. 5, the user information is managed as a user information table. As for the information registered in the user information table, it is possible to appropriately add, change, and/or delete the field.

The user information table exemplified in FIG. 5 is constructed to include respective fields of “apparatus ID”, “vehicle ID”, “distinction of sex”, “age”, “occupation”, “family structure”, and “interest”. The identification information (apparatus ID) for unambiguously identify or distinguish the apparatus 20 carried on the vehicle V1 is stored in the apparatus ID. The apparatus ID may include the IP address and/or the MAC address (Media Access Control address) of the apparatus 20. The identification information (vehicle ID) for unambiguously identifying the vehicle V1 is stored in the vehicle ID. The vehicle ID is, for example, the automobile registration number (number marked on number plate or license plate).

The information for indicating the distinction of sex of the user (for example, man, woman) is stored in the distinction of sex. The information for indicating the age (generation) of the user is stored in the age. The information for indicating the occupation of the user is stored in the occupation. The occupation may include the information for indicating the type of industry or business and/or the type of occupation. The information (for example, number of members) for indicating the family structure of the user is stored in the family structure.

The information for indicating the hobby and/or the interested matter of concern of the user is stored in the interest. A plurality of pieces of information to be stored in the field can be registered. In the example illustrated in FIG. 5, the three pieces of information of interest are exemplified. For example, in the case of the user ID “U101” who is a man of the age of “forties”, “angling”, “hot spring”, and “animal viewing for pleasure” are stored. In the case of the user ID “U102” who is a woman of the age of “thirties”, “trip”, “eating tour”, and “yoga” are stored.

The advertisement delivery unit 12 specifies the record registered in the user information DB 13 on the basis of the apparatus ID of the apparatus 20#2 carried on the chasing vehicle V1. Then, the advertisement delivery unit 12 selects the advertisement information to be delivered to the chasing vehicle V1 on the basis of the attribute information of the user (for example, distinction of sex, age, occupation, family structure, and interest) stored in the record.

With reference to FIG. 4 again, the advertisement information DB 14 manages the advertisement information to be delivered to the vehicle V1. The server 10 accepts the data relevant to the advertisement information, for example, by the aid of a server apparatus managed by an enterprise, a store, a facility or the like as the advertiser, and the data is registered in the advertisement information DB 14. The advertiser includes, for example, a public institution in the region and an advertising agency for mediating the delivery of the advertisement.

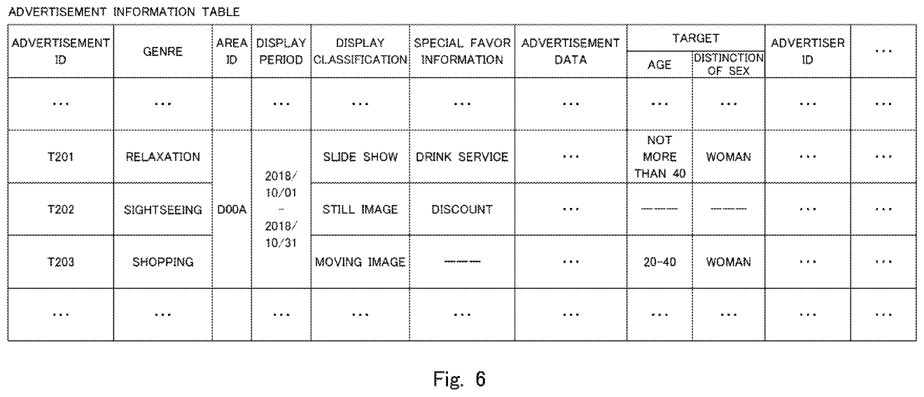

FIG. 6 illustrates exemplary advertisement information stored in the advertisement information DB 14. As exemplified in FIG. 6, the advertisement information is managed as an advertisement information table. As for the information registered in the advertisement information table, it is possible to appropriately add, change, and/or delete the field.

The advertisement information table exemplified in FIG. 6 has respective fields of “advertisement ID”, “genre”, “area ID”, “display period”, “display classification”, “special favor information”, “advertisement data”, “target”, and “advertiser ID”. The identification information (advertisement ID) for identifying the advertisement content accepted from the advertiser is stored in the advertisement ID. The advertisement ID is given when the advertisement content is registered. The information for indicating the division to which the merchandise or the service advertised by the advertisement information belongs is stored in the genre. The information (area ID) for indicating the region in which the store, the facility or the like for providing the merchandise or the service is positioned is stored in the area ID. The area ID is, for example, the region mesh information (for example, standard region mesh, or divided region mesh) of the region in which the store, the facility or the like is positioned.

The information for indicating the period in which the advertisement information is to be delivered is stored in the display period. The display period may include the time zone for displaying the advertisement information. The information for displaying the display form of the advertisement content is stored in the display classification. For example, the still image, the slide show, and the moving image are exemplified as the display form of the advertisement content. The content of the special favor (for example, coupon and/or discount of usage charge) provided to the user by the advertiser is stored in the special favor information. Note that if the special favor information is absent, the information for indicating the absence of the special favor information (for example, “---” or blank) is stored. The data of the advertisement content is stored in the advertisement data. However, the information stored in the advertisement data may be the identification number for indicating the advertisement data stored, for example, in any other table.

The information for designating the user as the advertisement target of the advertisement content is stored in the target. A plurality of pieces of information can be registered as the information stored in the field. In the example illustrated in FIG. 6, the pieces of information for designating the age and the distinction of sex are exemplified. For example, in the case of the advertisement ID “T201”, the distinction of sex of “woman” having the age of “not more than 40” is designated as the target. In the case of the advertisement ID “T203”, the distinction of sex of “woman” having the age of “20-40” is designated as the target. Note that if the designation of the user as the advertisement target is absent, the information for indicating the absence of the designation (for example, “---” or blank) is stored. The identification information (advertiser ID) for identifying the provider of the advertisement information is stored in the advertiser ID. The advertiser ID is, for example, an entrepreneur code given to the provider of the advertisement information.

In the example illustrated in FIG. 6, the advertisement ID's “T201”, “T202”, “T203”, which are provided, for example, by the store and the facility positioned in the area ID “DOOR”, are exemplified. The advertisement ID “T201” is the advertisement information of the facility or the like which provides, for example, the service of the genre “relaxation” such as the aromatherapy. The advertisement ID “T202” is the advertisement information of the store, the facility or the like which provides, for example, the service of the genre “sightseeing” such as the hot spring and the athletic field. The advertisement ID “T203” is the advertisement information of the store, the shopping district or the like which provides, for example, the service of the genre “shopping” such as the department store or the like.

The advertisement delivery unit 12 selects the advertisement information on the basis of the genre of the advertisement information registered in the advertisement information DB 14 and the attribute information of the user (for example, distinction of sex, age, occupation, family structure, and interest) registered in the user information DB 13. For example, the advertisement ID “T202”, which is divided into the genres “sightseeing” illustrated in FIG. 6, is selected as the relevant advertisement information with respect to the user ID “U101” having “hot spring” stored in the interest field illustrated in FIG. 5 and the user ID “U102” having “trip”, “eating tour” stored in the interest field illustrated in FIG. 5.

With reference to FIG. 4 again, the map information, which includes the map data including the planimetric feature positions and the POI (Point of interest) information of letters or characters, photographs and the like for indicating the characteristics of the respective points on the map data, is stored in the map information DB 15. Note that the map information DB 15 may be provided by any other system connected to the network N1, for example, GIS (Geographic Information System).

(Process Flow)

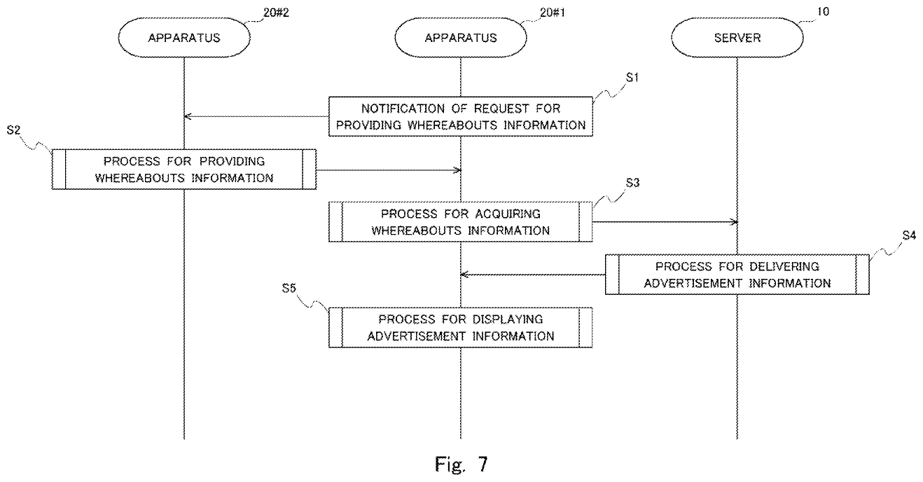

Next, an explanation will be made about the processes of the advertisement system 1 according to this embodiment with reference to FIGS. 7 to 11. The processes illustrated in FIGS. 7 to 11 are executed periodically. FIG. 7 illustrates a sequence diagram illustrating an exemplary processing procedure executed by the server 10, the apparatus 20#1 carried on the preceding vehicle V1, and the apparatus 20#2 carried on the chasing vehicle V1.

With reference to FIG. 7, the apparatus 20#1 carried on the preceding vehicle V1 notifies the apparatus 20#2 carried on the chasing vehicle V1 of the request for providing the whereabouts information (destination information, route information) in relation to the whereabouts or destination (S1). The request for providing the whereabouts information is made after establishing the link of the inter-vehicle communication between the preceding vehicle V1 and the chasing vehicle V1. The apparatus 20#1 notifies the apparatus 20#2 of the request for providing the whereabouts information by using the apparatus ID of the apparatus 20#2 as the destination or address.

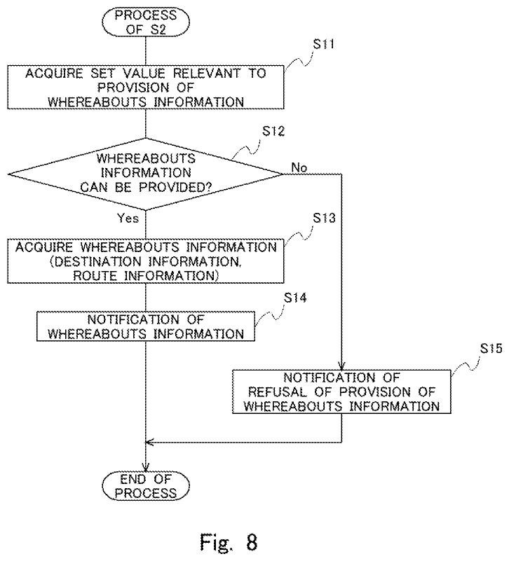

If the notification of the request for providing the whereabouts information is accepted from the preceding vehicle V1 (apparatus 20#1), the apparatus 20#2 executes the process for providing the whereabouts information (S2). The apparatus 20#1 is notified of the result of the process of S2 as the response to the request for providing the whereabouts information. Details of the process of S2 will be explained with reference to FIG. 8.

FIG. 8 illustrates a flow chart illustrating a detailed exemplary process of S2. The process illustrated in FIG. 8 is executed by taking the opportunity of the notification of the request for providing the whereabouts information. With reference to FIG. 8, the apparatus 20#2 of the chasing vehicle V1 acquires the set value relevant to the provision of the whereabouts information stored in the auxiliary storage unit 203 (S11). The set value is set, for example, by means of the input operation performed by the user of the chasing vehicle V1, and the set value is stored in a predetermined area of the auxiliary storage unit 203.

The apparatus 20#2 judges whether or not the whereabouts information can be provided on the basis of the status value of the set value (S12). If the set value is in the active status to indicate the permission (S12, “Yes”), the apparatus 20#2 proceeds to the process of S13. On the other hand, if the set value is in the non-active status to indicate the refusal (S12, “No”), the apparatus 20#2 proceeds to the process of S15.

In the process of S13, the apparatus 20#2 acquires, for example, the destination information and the route information retained in the main storage unit 202. Then, the apparatus 20#2 notifies the apparatus 20#1 of, for example, the acquired destination information and the acquired route information as the response to the request for providing the whereabouts information (S14). In the process of S15, the apparatus 20#2 notifies the apparatus 20#1 of the information to indicate the refusal of provision as the response to the request for providing the whereabouts information. The information to indicate the refusal of provision is previously determined by the advertisement system 1. After the processes of S14 and S15, the process illustrated in FIG. 8 is terminated.

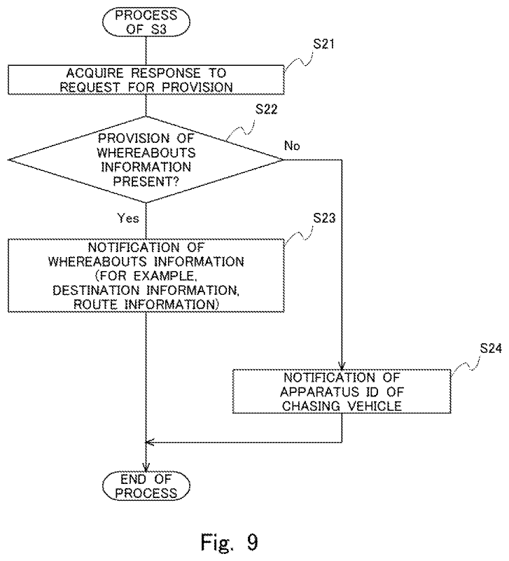

With reference to FIG. 7 again, if the apparatus 20#1 accepts the result of the process for providing the whereabouts information notified from the chasing vehicle V1 (apparatus 20#2), the apparatus 20#1 executes the process for acquiring the whereabouts information (S3). The server 10, which delivers the advertisement information, is notified of the result of the process of S3. Details of the process of S3 will be explained with reference to FIG. 9.

FIG. 9 illustrates a flow chart illustrating a detailed exemplary process of S3. With reference to FIG. 9, the apparatus 20#1 of the preceding vehicle V1 acquires the response to the request for providing the whereabouts information with respect to the chasing vehicle V1 (S21). The apparatus 20#1 temporarily stores the acquired response in a predetermined area of the main storage unit 202. The apparatus 20#1 judges whether or not the whereabouts information of the chasing vehicle V1 is provided on the basis of the acquired response (S22). For example, if the acquired response includes the information which indicates the whereabouts information, it is judged that the whereabouts information of the chasing vehicle V1 is provided. On the other hand, if the acquired response includes the information which indicates the refusal of the provision previously decided by the advertisement system 1, it is judged that the whereabouts information of the chasing vehicle V1 is not provided.

If the whereabouts information of the chasing vehicle V1 is provided (S22, “Yes”), the apparatus 20#1 proceeds to the process of S23. On the other hand, if the whereabouts information of the chasing vehicle V1 is not provided (S22, “No”), the apparatus 20#1 proceeds to the process of S24.

In the process of S23, the apparatus 20#1 notifies the server 10 of the whereabouts information (for example, destination information, route information) provided from the chasing vehicle V1 together with the apparatus ID of the apparatus 20#2. In the process of S24, the apparatus 20#1 notifies the server 10 of the apparatus ID of the apparatus 20#2. The apparatus 20#1 transmits the result of the process for acquiring the whereabouts information to the network N1 by using the apparatus ID of the subject apparatus as the transmission source and using the server 10 as the destination or address. In the server 10, the advertisement information, which is to be delivered to the preceding vehicle V1, is selected on the basis of the received result of the process for acquiring the whereabouts information. After the processes of S23 and S24, the process illustrated in FIG. 9 is terminated.

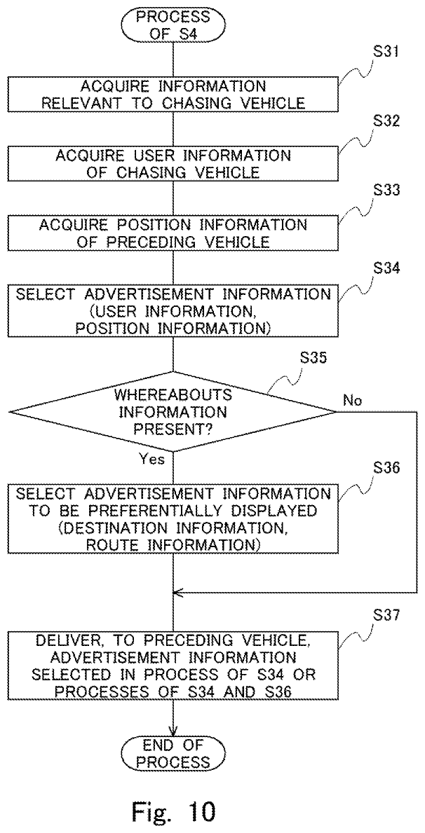

With reference to FIG. 7 again, if the server 10 accepts the result of the process for acquiring the whereabouts information notified from the preceding vehicle V1 (apparatus 20#1), the server 10 executes the process for delivering the advertisement information (S4). The advertisement information selected in the process of S4 is delivered to the preceding vehicle V1. Details of the process of S4 will be explained with reference to FIG. 10.

FIG. 10 illustrates a flow chart illustrating a detailed exemplary process of S4. With reference to FIG. 10, the server 10 acquires the information relevant to the chasing vehicle V1 notified from the apparatus 20#1 of the preceding vehicle V1 (S31). The information relevant to the chasing vehicle V1 is the apparatus ID of the chasing vehicle V1 notified as the result of the process illustrated in FIG. 9, or the apparatus ID and the whereabouts information of the chasing vehicle V1 notified as the result of the process illustrated in FIG. 9. The server 10 temporarily stores the acquired information relevant to the chasing vehicle V1 in a predetermined area of the main storage unit 102, while being correlated with the apparatus ID of the apparatus 20#1 of the preceding vehicle V1 and the time information.

In the process of S32, the user information of the chasing vehicle V1 is acquired. The server 10 makes reference to the user information DB 13 on the basis of the apparatus ID of the apparatus 20#2 to specify the record corresponding to the apparatus ID. The record, which is specified from the user information DB 13 and which is stored with the user information of the chasing vehicle V1, is delivered by the server 10 to the process of S34.

In the process of S33, the position information of the preceding vehicle V1 is acquired. The server 10 requests the notification of the position information by using, for example, the apparatus ID of the apparatus 20#1 as the destination or address. The preceding vehicle V1 acquires the present position information of the subject vehicle, for example, by the aid of the position information detecting unit 207, and the server 10 is notified of the position information. The server 10 acquires the position information responded from the preceding vehicle V1, and the position information is delivered to the process of S34.

In the process of S34, the advertisement information is selected on the basis of the information relevant to the user of the chasing vehicle V1 and the position information of the preceding vehicle V1 which travels while preceding the chasing vehicle V1. The server 10 makes reference, for example, to the advertisement information DB 14 to specify the advertisement information relevant to the attribute information of the user (for example, distinction of sex, age, occupation, family structure, interest). For example, the advertisement information, which is divided into the genre corresponding, for example, to the interest of the user, is specified. Further, the advertisement information, in which the distinction of sex, the age, the occupation, and the family structure of the user conform to the condition designated in the target field, is specified.

Further, the server 10 may further select the advertisement information as specified in accordance with the attribute information of the user on the basis of the position information acquired from the preceding vehicle V1. It is possible to appropriately select the advertisement information of the store or the like which is adapted to the area in which the preceding vehicle V1 and the chasing vehicle V1 travel. The server 10 delivers, to the process of S37, the advertisement information relevant to the attribute information of the user and the present position information of the preceding vehicle V1.

In the process of S35, it is judged whether or not the whereabouts information is included in the information relevant to the chasing vehicle V1. If the whereabouts information of the chasing vehicle V1 is included (S35, “Yes”), the server 10 proceeds to the process of S36. On the other hand, if the whereabouts information of the chasing vehicle V1 is not included (S35, “No”), the server 10 proceeds to the process of S37.

In the process of S36, the advertisement information, which is to be preferentially displayed as compared with the advertisement information selected from the attribute information of the user and the position information to indicate the traveling position, is selected. The server 10 makes reference, for example, to the advertisement information DB 14 to specify the advertisement information relevant to the whereabouts information of the user of the chasing vehicle V1. The advertisement information is specified on the basis of the position information and the route information of the destination and the area ID registered in the record of the advertisement information. For example, if the destination information of the user is included in the area indicated by the area ID, the advertisement information, which stores the area ID in the record, is specified as the advertisement information relevant to the whereabouts information. Further, if the region, which is indicated by the area ID, exists on the route, the advertisement information, which stores the area ID in the record, is specified as the advertisement information relevant to the whereabouts information. The server 10 gives the designation information (identifier) for the preferential display to the advertisement information relevant to the whereabouts information, and the information is delivered to the process of S37.

In the process of S37, the advertisement information, which is selected in the process of S34 or the processes of S34 and S36, is delivered by the server 10 to the preceding vehicle V1 via the network N1. If the chasing vehicle V1 refuses the provision of the whereabouts information, the advertisement information, which is relevant to the user information specified on the basis of the apparatus ID of the apparatus 20#2 and the position information of the traveling position, is delivered to the preceding vehicle V1. Further, if the whereabouts information of the chasing vehicle V1 is provided, the advertisement information relevant to the user information and the position information of the traveling position, and the advertisement information relevant to the whereabouts information to which the designation of the preferential display is given are delivered to the preceding vehicle V1. After the process of S37, the process illustrated in FIG. 10 is terminated.

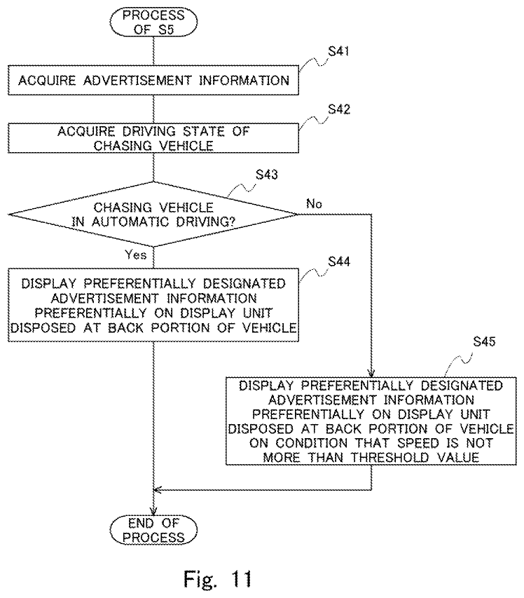

With reference to FIG. 7 again, if the apparatus 20#1 accepts the advertisement information delivered from the server 10, the apparatus 20#1 executes the process for displaying the advertisement information (S5). In accordance with the process of S5, the advertisement information relevant to the whereabouts information of the chasing vehicle V1 is displayed on the display apparatus (display unit 204B) disposed at the back portion of the vehicle, preferentially as compared with the advertisement information relevant to the user information of the chasing vehicle and the position information of the traveling position. Details of the process of S5 will be explained with reference to FIG. 11.

FIG. 11 illustrates a flow chart illustrating a detailed exemplary process of S5. With reference to FIG. 11, the apparatus 20#1 of the preceding vehicle V1 acquires the advertisement information delivered from the server 10 (S41). The apparatus 20#1 temporarily stores the acquired advertisement information in a predetermined area of the main storage unit 202. Then, the apparatus 20#1 acquires the driving state of the chasing vehicle V1 (S42).

The apparatus 20#1 transmits the request for notification of the driving state by means of the inter-vehicle communication by using, for example, the apparatus ID of the apparatus 20#2 of the chasing vehicle V1 as the destination or address. If the apparatus 20#2 accepts the request for notification of the driving state from the preceding vehicle V1, the apparatus 20#2 acquires the status value which indicates whether the driving assistance function of the subject vehicle is effective (ON status) or not (OFF status) by the aid of the sensor 208. In this case, the driving assistance function as the acquisition target is, for example, the cruise control for allowing the vehicle to travel at a previously set speed without continuously pedaling the accelerator pedal by the driver. Further, for example, the acquisition target is the following drive assistance function (radar cruise control) for allowing the vehicle to travel while following the preceding vehicle V1 by adjusting the speed of the subject vehicle while maintaining a constant following distance with respect to the preceding vehicle V1 detected, for example, by a radar and/or a camera.

The apparatus 20#2 acquires the ON/OFF status to indicate whether or not the driving assistance function is effective by the aid of the sensor 208. Note that the turning ON/OFF of the driving assistance function is set in accordance with the switch operation or the button operation by the user of the chasing vehicle V1. The apparatus 20#2 transmits the acquired ON/OFF status of the driving assistance function to the apparatus 20#1 as the response to the request for notification of the driving state. The apparatus 20#1 of the preceding vehicle V1 acquires the ON/OFF status of the driving assistance function transmitted from the chasing vehicle V1 by means of the inter-vehicle communication.

In the process of S43, the driving state of the chasing vehicle V1 is judged. If the driving assistance function acquired from the chasing vehicle V1 is in the ON status, the apparatus 20#1 judges that the vehicle is in the driving state (automatic driving) in which the cruise control or the radar cruise control is allowed to function.

On the other hand, if the driving assistance function acquired from the chasing vehicle V1 is in the OFF status, the apparatus 20#1 judges that the vehicle is not in the driving state in which the cruise control or the radar cruise control is allowed to function.

If the apparatus 20#1 judges that the driving state of the chasing vehicle V1 is the automatic driving (S43, “Yes”), the apparatus 20#1 proceeds to the process of S44. In the process of S44, the advertisement information, which is subjected to the preferential designation (designation of the preferential display), is displayed on the display apparatus (display unit 204B) disposed at the back portion of the vehicle preferentially as compared with the advertisement information which has no preferential designation.

On the other hand, if the apparatus 20#1 judges that the driving state of the chasing vehicle V1 is not the automatic driving (S43, “No”), the apparatus 20#1 proceeds to the process of S45. In the process of S45, the advertisement information, which is subjected to the preferential designation (designation of the preferential display), is displayed on the display apparatus (display unit 204B) disposed at the back portion of the vehicle preferentially as compared with the advertisement information which has no preferential designation, on condition that the speed of the subject vehicle is not more than a predetermined threshold value (for example, 20 km/h).

In accordance with the processes of S43 to S45, the apparatus 20#1, which is carried on the preceding vehicle V1, can display the advertisement information while taking account of the safety of the traveling of the vehicle V1, without always displaying the selected advertisement information. After the processes of S44 and S45, the process illustrated in FIG. 11 is terminated, and the process illustrated in FIG. 7 is terminated.

According to the process as described above, in the advertisement system 1 concerning this embodiment, the apparatus 20#1 of the preceding vehicle V1 can acquire the whereabouts information relevant to the whereabouts or destination (for example, destination information, route information) from the chasing vehicle V1 which travels while following the subject vehicle. The server 10 according to this embodiment can select the advertisement information relevant to the whereabouts information on the basis of the whereabouts information of the chasing vehicle V1 notified from the apparatus 20#1. Further, the server 10 can specify the information relevant to the user on the basis of the apparatus ID of the apparatus 20#2 carried on the chasing vehicle V1, and the server 10 can select the advertisement information relevant to the information in relation to the user. Then, the server 10 can give the designation information to display the advertisement information relevant to the whereabouts information preferentially as compared with any other advertisement information, to the advertisement information relevant to the whereabouts information, and the server 10 can deliver the advertisement information to the preceding vehicle V1. The preceding vehicle V1 can display the advertisement information relevant to the whereabouts information of the chasing vehicle V1 preferentially on the basis of the designation information on the display apparatus (display unit 204B) provided at the back portion of the vehicle.

According to this embodiment, when the trip or the travel (transfer or transport) is made by driving and operating the chasing vehicle V1, the advertisement information relevant to the whereabouts information can be preferentially displayed. Therefore, it is possible to effectively provide the advertisement information desired by the passenger who gets on the chasing vehicle V1.

Further, in the advertisement system 1 according to this embodiment, the apparatus 20#1 of the preceding vehicle V1 can display the advertisement information in accordance with the driving state of the chasing vehicle V1. For example, if the cruise control or the radar cruise control of the chasing vehicle V1 is effective, the advertisement information is displayed with respect to the back of the vehicle of the subject vehicle which is traveling. The driving operation of the driver is assisted in the driving state in which the driving assistance function is used. Therefore, it is possible to provide the advertisement information while taking account of the safety of the traveling.

Note that in the advertisement system 1 according to this embodiment, the apparatus 20#2 carried on the chasing vehicle V1 can refuse the provision of the whereabouts information. In this embodiment, it is possible to suppress any unnecessary outflow of the personal information of the user, while considering the intension of the user who does not desire the provision of the whereabouts information.

### First Modified Embodiment

In the first embodiment, the preceding vehicle V1 acquires the whereabouts information of the chasing vehicle V1, and the preceding vehicle V1 displays the advertisement information on the display apparatus disposed at the back portion of the vehicle in accordance with the driving state of the chasing vehicle. In the meantime, the advertisement information relevant to the whereabouts information can be also displayed while allowing the chasing vehicle V1 to play a major role. In an advertisement system 1 of a first modified embodiment, the advertisement information relevant to the whereabouts information is displayed on the display apparatus provided at the back portion of the vehicle of the preceding vehicle V1 while allowing the chasing vehicle V1 to play the major role.

The apparatus 20#2 of the first modified embodiment transmits the whereabouts information to the server 10, for example, taking the opportunity of the operation of the switch or the operation of the button for providing the effective driving assistance function including, for example, the cruise control and the radar cruise control after establishing the inter-vehicle communication with respect to the preceding vehicle V1. The apparatus 20#2 transmits, to the server 10, the apparatus ID of the apparatus 20#1 carried on the preceding vehicle V1 and the information (identifier) to indicate that the subject vehicle is the chasing vehicle V1 which chases the preceding vehicle V1, together with the apparatus ID of the subject apparatus.

The server 10 of the first modified embodiment acquires the information transmitted from the apparatus 20#2 via the network N1. Then, the server 10 of the first modified embodiment specifies that the apparatus 20#2 is the vehicle onboard apparatus carried on the chasing vehicle V1 which chases the preceding vehicle V1, on the basis of the identifier. The server 10 according to the first modified embodiment executes the process illustrated in FIG. 10 on the basis of the position information and the whereabouts information transmitted from the apparatus 20#2, and the server 10 according to the first modified embodiment selects the advertisement information to be delivered to the apparatus 20#1 of the preceding vehicle V1.

If the apparatus 20#1 of the first modified embodiment acquires the advertisement information delivered from the server 10 (FIG. 11, S41), the apparatus 20#1 skips the processes of S42, S43, S45 illustrated in FIG. 11, and the apparatus 20#1 displays the advertisement information on the display apparatus disposed at the back portion of the vehicle (FIG. 11, S44).

Also in the form of the first modified embodiment, the advertisement system 1 can preferentially display the advertisement information relevant to the whereabouts information. Therefore, it is possible to effectively provide the advertisement information desired by the passenger who gets on the chasing vehicle V1, while considering the safety of the traveling.

### Other Embodiments

The foregoing embodiment has been described by way of example in every sense. The disclosure of the embodiment of the present disclosure can be carried out while being appropriately changed within a range without deviating from the gist or essential characteristics thereof. The processes and the means explained in this disclosure can be carried out while freely combining them unless any technical contradiction or inconsistency arises.

Further, the process, which has been explained as being performed by one apparatus or device, may be executed by a plurality of apparatuses or devices in a shared manner. Alternatively, the process, which has been explained as being performed by the different apparatuses or devices, may be executed by one apparatus or device without causing any problem. In the computer system, it is possible to flexibly change the way of realization of the respective functions by means of any hardware configuration (server configuration).

A program, which allows the information processing apparatus or any other machine, apparatus, or device (hereinafter referred to as “computer or the like”) to realize any one of the functions described above, can be recorded on a recording medium which can be read by the computer or the like. Then, it is possible to provide the function by allowing the computer or the like to read and execute the program on the recording medium.

In this context, the recording medium, which can be read by the computer or the like, refers to a recording medium on which the information of the data, the program or the like can be accumulated in accordance with the electric, magnetic, optical, mechanical, or chemical action, and the information can be read from the computer or the like. Those included in the recording medium as described above, which can be removed from the computer or the like, include, for example, flexible disk, magneto-optical disk, CD-ROM, CD-R/W, DVD, Blu-ray Disc, DAT, 8 mm tape, and memory card such as flash memory or the like. Further, the recording medium, which is fixed to the computer or the like, includes, for example, hard disk and ROM.

What is claimed is:

1. An information system comprising a controller comprising at least one processor configured to execute:
acquisition of destination information relevant to a destination and route information relevant to a route until arrival at the destination of a second vehicle which chases a first vehicle; and
display of advertisement information relevant to the destination information and the route information in relation to the second vehicle, on a display unit which is provided on the first vehicle and which displays information with respect to those disposed at the back of the first vehicle.

2. The information system according to claim 1, wherein the controller further executes the display of the advertisement information if the second vehicle is in a driving assistance state in which the second vehicle travels in accordance with a set speed value, or if the second vehicle is in a driving assistance state in which the second vehicle travels while maintaining a constant following distance with respect to the first vehicle.

3. The information system according to claim 1, wherein the second vehicle has means for refusing provision of any data relevant to the destination information and the route information.

4. An information processing method comprising:
acquiring destination information relevant to a destination and route information relevant to a route until arrival at the destination of a second vehicle which chases a first vehicle; and
displaying advertisement information relevant to the destination information and the route information in relation to the second vehicle, on a display unit which is provided on the first vehicle and which displays information with respect to those disposed at the back of the first vehicle.

5. A non-transitory storage medium stored with a program for allowing a computer to execute:
acquisition of destination information relevant to a destination and route information relevant to a route until arrival at the destination of a second vehicle which chases a first vehicle; and
display of advertisement information relevant to the destination information and the route information in relation to the second vehicle, on a display unit which is provided on the first vehicle and which displays information with respect to those disposed at the back of the first vehicle.
